(19) United States
(12) Patent Application Publication
(10) Pub. No.: US 2006/0238964 A1
(43) Pub. Date: Oct. 26, 2006

(54) Display apparatus for a multi-display card and displaying method of the same

(76) Inventors: Cho-Hsine Liao, Taipei Hsien (TW); Ju-Yi Hung, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/113,152

(22) Filed: Apr. 25, 2005

(51) Int. Cl. G06F 1/16

(52) U.S. Cl. 361/681

(57) ABSTRACT

A display apparatus for a multi-display card and displaying method of the same is disclosed. The display apparatus for a multi-display card comprises: a first chipset with a first socket, a second chipset with a second socket, a first display card, a second display card, and a connector. The first display card is inserted into the first socket and the second display card is inserted into the second socket, and the connector is connected between the first display card and the second display card. The first display card and the second display card are controlled separately through the first chipset and the second chipset for handling image processing, and the first display card and the second display card are co-operated through the connector to output a video signal. Thereby, it increases the efficiency of the image processing.

### BACKGROUND OF THE INVENTION

1. Field of the Invention

The present invention relates to a display apparatus and a displaying method of the same, and more particularly to a display apparatus for a multi-display card and displaying method of the same.

2. Description of Related Art

3D computer games and high-definition dynamic image technology has advanced at an astounding speed of late. There is a continuing need to provide faster image processing so as to process larger and larger amounts of data to meet the demands both of consumers and the producers of this kind of technology. For a computer system, a display card is the main device for handling the image processing. Hence, in order to accelerate processing speeds, it is not only necessary to increase the capabilities of the display card's Graphic Processing Unit (GPU), but also to use multiple display cards.

Reference is made to FIG. 1 that is a system architecture according to the prior art, i.e. the architecture of a SLI (Scalable Link Interface). In SLI technology there are two display cards inserted on a motherboard A north bridge chipset 70 on the motherboard provides a first socket 71 and a second socket 72 has a separate PCI-E (PCI-Express) interface. A first display card 81 is inserted into the first socket 71 and a second display card 82 is inserted into the second socket 72. Moreover, a connector 90 is connected between the first display card 81 and the second display card 82 for transmitting data between the first display card 81 and the second display card 82.

Furthermore, each GPU of the first display card 81 and the second display card 82 provides support for communication protocols, and the first display card 81 and the second display card 82 also provide support for high-speed digital interface to connect to a connector 90 for transmitting data between the first display card 81 and the second display card 82 thereby controlling the dynamic load balancing, the advanced rendering, and synthesis between the first display card 81 and the second display card 82.

However, the north bridge chipset 70 provides two PCI-E×16 sockets to allow two display cards to be inserted. Hence, it causes a heavy workload for the north bridge chipset 70.

The inventor of the present invention recognizes the above disadvantage should be corrected and special effort has been paid to research within this field. The present invention is presented with reasonable design and good effect to resolve the above problems.

### SUMMARY OF THE INVENTION

It is an objective of the present invention to provide a display apparatus for a multi-display card and a displaying method of the same for achieving the SLI (Scalable Link Interface) technology by means of the multi-chipsets to increase the work efficiency of the image processing cards.

For achieving the objective stated above, a method for displaying a multi-display card, comprises:

(a) inserting a first display card into a first socket, wherein the first socket is controlled through a first chipset;

(b) inserting a second display card into a second socket, wherein the second socket is controlled through a second chipset;

(c) connecting the first display card with the second display card through a connector; and

(d) outputting a video signal; wherein the first display card and the second display card are controlled separately through the first chipset and the second chipset for handling image processing, and the first display card and the second display card are co-operated through the connector to output a video signal.

For achieving the objective stated above, a display apparatus for a multi-display card, comprises:

a first chipset with at least one first socket;

a second chipset with at least a second socket;

a first display card inserted into the first socket;

a second display card inserted into the second socket; and

a connector connected between the first display card and the second display card for transmitting data between the first display card and the second display card; wherein the first display card and the second display card are controlled separately through the first chipset and the second chipset for handling image processing, and the first display card and the second display card are co-operated through the connector to output a video signal.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

FIG. 1 is a system architecture according to the prior art; and

FIG. 2 is a system architecture according to a preferred embodiment of the present invention.

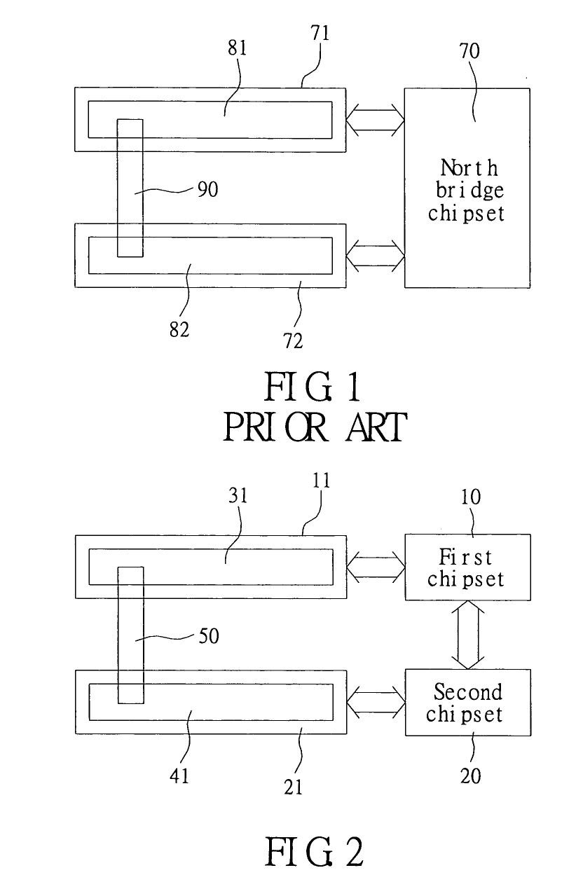

### DETAILED DESCRIPTION OF THE PREFERRED EMBODIMENTS

Reference is made to FIG. 2, which is a system architecture according to a preferred embodiment of the present invention. The present invention provides a display apparatus for providing support for a SLI (Scalable Link Interface) technology, which comprises a first chipset 10, a second chipset 20, a first display card 31, a second display card 41, and a connector 50.

Furthermore, a first socket 11 and a second socket 21 are supported separately through the first chipset 10 and the second chipset 20, thereby the first chipset 10 is a north bridge chipset and the second chipset 20 is a south bridge chipset. Moreover both the first socket 11 and the second socket 21 are PCI-E (PCI-Express) interfaces according to a preferred embodiment of the present invention.

A first display card 31 is inserted into the first socket 11, a second display card 41 is inserted into the second socket 21, and a connector 50 is connected between the first display card 31 and the second display card 41 for transmitting data between the first display card 31 and the second display card 41.

Furthermore, both of the first display card 31 and the second display card 41 provide support for SLI operations, each of the GPUs of the first display card 31 and the second display card 41 (not shown in figure) provide support for communication protocols. The first display card 31 and the second display card 41 also provide support for high-speed digital interface (not shown in figure) to transmit data.

Moreover, the first display card 31 and the second display card 32 are controlled separately through the first chipset 10 and the second chipset 20 for handling image processing, and the connector 50 is connected between the first display card 31 and the second display card 41 for transmitting data between the first display card 31 and the second display card 41 to control the dynamic load balancing, the advanced rendering, and synthesis between the first display card 31 and the second display card 41.

In addition, when a video signal is outputted through the first display card 31, the second display 41 will share the amount of processed data.

As mentioned above, the present invention provides two chipsets with PIC-E×16 sockets for two display cards to be inserted correspondingly. The two chipsets are processed separately to increase the efficiency of the image processing.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of displaying a multi-display card, comprising:
(a) inserting a first display card into a first socket, wherein the first socket is controlled through a first chipset;
(b) inserting a second display card into a second socket, wherein the second socket is controlled through a second chipset;
(c) connecting the first display card with the second display card through a connector; and
(d) outputting a video signal; wherein the first display card and the second display card are controlled separately through the first chipset and the second chipset for handling image processing, and the first display card and the second display card are co-operated through the connector to output a video signal.

2. The method for displaying a multi-display card as in claim 1, wherein both the first socket and the second socket are PCI-E (PCI-Express) interfaces.

3. The method for displaying a multi-display card as in claim 2, wherein a specification of the PCI-E interface is PCI-E×16.

4. The method for displaying a multi-display card as in claim 1, wherein the first chipset is a north bridge chipset and the second chipset is a south bridge chipset.

5. The method for displaying a multi-display card as in claim 1, wherein the video information is outputted through the first display card.

6. The method for displaying a multi-display card as in claim 1, wherein in the step (d) the first display card and the second display card are co-operated through the connector by means of operation loads of the first display card and the second display card, balanced through a driver.

7. A display apparatus for a multi-display card, comprising:
a first chipset with at least a first socket;
a second chipset with at least a second socket;
a first display card inserted into the first socket;
a second display card inserted into the second socket; and
a connector connected between the first display card and the second display card for transmitting data between the first display card and the second display card; wherein the first display card and the second display card are controlled separately through the first chipset and the second chipset for handling image processing, and the first display card and the second display card are co-operated through the connector to output a video signal.

8. The display apparatus for a multi-display card as in claim 7, wherein both the first socket and the second socket are PCI-I (PCI-Express) interfaces.

9. The display apparatus for a multi-display card as in claim 8, wherein a specification of the PCI-E interface is PCI-E×16.

10. A display apparatus for a multi-display card as in claim 7, wherein the first chipset is a north bridge chipset and the second chipset is a south bridge chipset.

11. A display apparatus for a multi-display card as in claim 7, wherein the video signal is outputted through the first display card.
